(19) United States
(12) Patent Application Publication
(10) Pub. No.: US 2026/0120945 A1
(43) Pub. Date: Apr. 30, 2026

(54) MAGNET AND METHOD OF MAKING MAGNETS FOR AN ELECTRIC MACHINE

(71) Applicant: FORD GLOBAL TECHNOLOGIES, LLC, Dearborn, MI (US)

(72) Inventors: Wanfeng Li, Novi, MI (US); Chuanbing Rong, Canton, MI (US); Michael W. Degner, Novi, MI (US)

(21) Appl. No.: 18/925,620

(22) Filed: Oct. 24, 2024

(51) Int. Cl. H01F 41/02; H01F 1/03; H01F 7/02; H01F 13/00

(52) U.S. Cl. CPC H01F 41/0266; H01F 1/0306; H01F 7/021; H01F 13/003

(57) ABSTRACT

A method for forming magnets includes compacting particles of a metallic powder to form a magnet with homogeneous coercivity. The method further includes thermal gradient annealing the magnet to selectively promote grain growth within the magnet such that grain size of the magnet decreases in a direction of a temperature gradient corresponding to regions of lower temperature.

### TECHNICAL FIELD

The present disclosure relates electric machines utilized in hybrid or electric vehicles and magnets that may be utilized in such electric machines.

### BACKGROUND

Hybrid and electric vehicles may be propelled by an electric machine that draws power from a battery.

### SUMMARY

A method for forming magnets comprising: compacting particles of a metallic powder to form a magnet with homogeneous coercivity; and thermal gradient annealing the magnet to selectively promote grain growth within the magnet such that grain size of the magnet decreases in a direction of a temperature gradient corresponding to regions of lower temperature and the coercivity increases in the direction.

A method for forming magnets comprising: compacting particles of a metallic powder to form a magnet with homogeneous coercivity; deforming the magnet within a die via a press to form the magnet into a shape; and controlling a temperature of the die, the press, or the magnet to generate a temperature gradient across the magnet to thermal gradient anneal the magnet and selectively promote grain growth within the magnet such that grain size of the magnet decreases in a direction of the temperature gradient corresponding to regions of lower temperature and the coercivity increases in the direction.

A magnet comprising an array of grains extending from a first end of the magnet toward a second end of the magnet. The grains within the array have aligned magnetic polarities, and grain sizes that decrease along a first direction extending from the first end toward the second end such that a coercivity of the magnet increases in the first direction.

### BRIEF DESCRIPTION OF THE DRAWINGS

FIG. 1 is a schematic illustration of a representative powertrain of an electric vehicle;

FIG. 2 is a schematic illustration of a portion of an electric machine;

FIG. 3 is a schematic illustration of a process for producing magnets that may be utilized in the electric machine;

FIG. 4 is a flowchart illustrating the process for producing the magnets;

FIG. 5 is a schematic illustration of a first magnet that may be produced by the process described in FIGS. 3 and 4;

FIG. 6 is a schematic illustration of a second magnet that may be produced by the process described in FIGS. 3 and 4;

FIG. 7 is a graph illustrating the gradient of coercivity across a magnet; and

FIG. 8 is a graph illustrating the relationship between grain size and coercivity.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

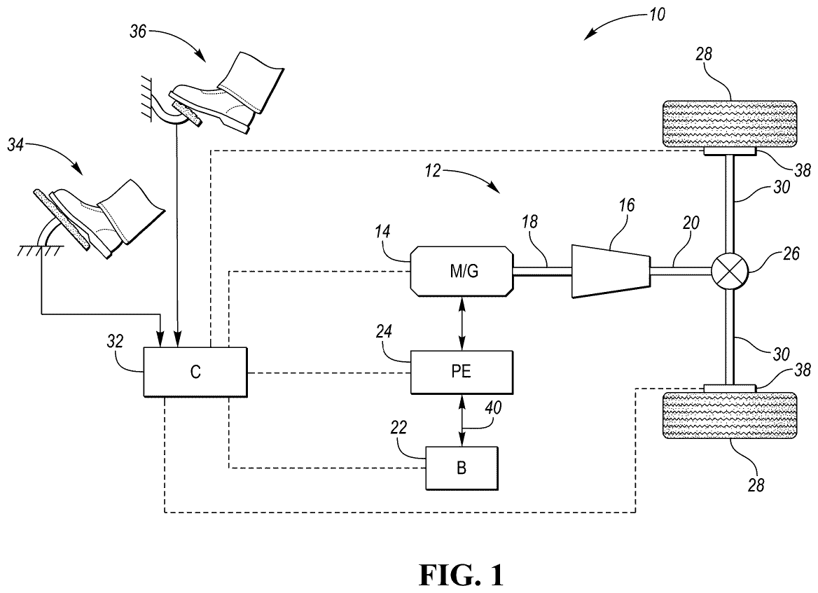

Referring to FIG. 1, a schematic diagram of an electric vehicle 10 is illustrated according to an embodiment of the present disclosure. FIG. 1 illustrates representative relationships among the components. Physical placement and orientation of the components within the vehicle may vary. The electric vehicle 10 includes a powertrain 12. The powertrain 12 includes an electric machine such as an electric motor/generator (M/G) 14 that drives a transmission (or gearbox) 16. More specifically, the M/G 14 may be rotatably connected to an input shaft 18 of the transmission 16. The transmission 16 may be placed in PRNDSL (park, reverse, neutral, drive, sport, low) via a transmission range selector (not shown). The transmission 16 may have a fixed gearing relationship that provides a single gear ratio between the input shaft 18 and an output shaft 20 of the transmission 16. A torque converter (not shown) or a launch clutch (not shown) may be disposed between the M/G 14 and the transmission 16. Alternatively, the transmission 16 may be a multiple step-ratio automatic transmission. An associated traction battery 22 is configured to deliver electrical power to or receive electrical power from the M/G 14.

The M/G 14 is a drive source for the electric vehicle 10 that is configured to propel the electric vehicle 10. The M/G 14 may be implemented by any one of a plurality of types of electric machines. For example, M/G 14 may be a permanent magnet synchronous motor. Power electronics 24 condition direct current (DC) power provided by the battery 22 to the requirements of the M/G 14, as will be described below. For example, the power electronics 24 may provide three phase alternating current (AC) to the M/G 14.

If the transmission 16 is a multiple step-ratio automatic transmission, the transmission 16 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the transmission output shaft 20 and the transmission input shaft 18. The transmission 16 is automatically shifted from one ratio to another based on various vehicle and ambient operating conditions by an associated controller, such as a powertrain control unit (PCU). Power and torque from the M/G 14 may be delivered to and received by transmission 16. The transmission 16 then provides powertrain output power and torque to output shaft 20.

It should be understood that the hydraulically controlled transmission 16, which may be coupled with a torque converter (not shown), is but one example of a gearbox or transmission arrangement; any multiple ratio gearbox that accepts input torque(s) from a power source (e.g., M/G 14) and then provides torque to an output shaft (e.g., output shaft 20) at the different ratios is acceptable for use with embodiments of the present disclosure. For example, the transmission 16 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 1, the output shaft 20 is connected to a differential 26. The differential 26 drives a pair of drive wheels 28 via respective axles 30 connected to the differential 26. The differential 26 transmits approximately equal torque to each wheel 28 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain 12 further includes an associated controller 32 such as a powertrain control unit (PCU). While illustrated as one controller, the controller 32 may be part of a larger control system and may be controlled by various other controllers throughout the vehicle 10, such as a vehicle system controller (VSC). It should therefore be understood that the powertrain control unit 32 and one or more other controllers can collectively be referred to as a “controller” that controls various actuators in response to signals from various sensors to control functions such as operating the M/G 14 to provide wheel torque or charge the battery 22, select or schedule transmission shifts, etc. Controller 32 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 32 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, controller 32 may communicate signals to and/or receive signals from the M/G 14, battery 22, transmission 16, power electronics 24, and any another component of the powertrain 12 that may be included, but is not shown in FIG. 1 (i.e., a launch clutch that may be disposed between the M/G 14 and the transmission 16. Although not explicitly illustrated, those of ordinary skill in the art will recognize various functions or components that may be controlled by controller 32 within each of the subsystems identified above. Representative examples of parameters, systems, and/or components that may be directly or indirectly actuated using control logic and/or algorithms executed by the controller 32 include front-end accessory drive (FEAD) components such as an alternator, air conditioning compressor, battery charging or discharging, regenerative braking, M/G 14 operation, clutch pressures for the transmission gearbox 16 or any other clutch that is part of the powertrain 12, and the like. Sensors communicating input through the I/O interface may be used to indicate wheel speeds (WS1, WS2), vehicle speed (VSS), coolant temperature (ECT), accelerator pedal position (PPS), ignition switch position (IGN), ambient air temperature (e.g., ambient air temperature sensor 33), transmission gear, ratio, or mode, transmission oil temperature (TOT), transmission input and output speed, deceleration or shift mode (MDE), battery temperature, voltage, current, or state of charge (SOC) for example.

Control logic or functions performed by controller 32 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle and/or powertrain controller, such as controller 32. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

An accelerator pedal 34 is used by the driver of the vehicle to provide a demanded torque, power, or drive command to the powertrain 12 (or more specifically M/G 14) to propel the vehicle. In general, depressing and releasing the accelerator pedal 34 generates an accelerator pedal position signal that may be interpreted by the controller 32 as a demand for increased power or decreased power, respectively. A brake pedal 36 is also used by the driver of the vehicle to provide a demanded braking torque to slow the vehicle. In general, depressing and releasing the brake pedal 36 generates a brake pedal position signal that may be interpreted by the controller 32 as a demand to decrease the vehicle speed. Based upon inputs from the accelerator pedal 34 and brake pedal 36, the controller 32 commands the torque and/or power to the M/G 14, and friction brakes 38. The controller 32 also controls the timing of gear shifts within the transmission 16.

The M/G 14 may act as a motor and provide a driving force for the powertrain 12. To drive the vehicle with the M/G 14 the traction battery 22 transmits stored electrical energy through wiring 40 to the power electronics 24 that may include inverter and rectifier circuitry, for example. The inverter circuitry of the power electronics 24 may convert DC voltage from the battery 22 into AC voltage to be used by the M/G 14. The rectifier circuitry of the power electronics 24 may convert AC voltage from the M/G 14 into DC voltage to be stored with the battery 22. The controller 32 commands the power electronics 24 to convert voltage from the battery 22 to an AC voltage provided to the M/G 14 to provide positive or negative torque to the input shaft 18.

The M/G 14 may also act as a generator and convert kinetic energy from the powertrain 12 into electric energy to be stored in the battery 22. More specifically, the M/G 14 may act as a generator during times of regenerative braking in which torque and rotational (or kinetic) energy from the spinning wheels 28 is transferred back through the transmission 16 and is converted into electrical energy for storage in the battery 22.

It should be understood that the vehicle configuration described herein is merely exemplary and is not intended to be limited. Other electric or hybrid electric vehicle configurations should be construed as disclosed herein. Other electric or hybrid vehicle configurations may include, but are not limited to, series hybrid vehicles, parallel hybrid vehicles, series-parallel hybrid vehicles, plug-in hybrid electric vehicles (PHEVs), fuel cell hybrid vehicles, battery operated electric vehicles (BEVs), or any other vehicle configuration known to a person of ordinary skill in the art.

In hybrid configurations that include an internal combustion engine such as a gasoline, diesel, or natural gas powered engine, or a fuel cell, the controller 32 may be configured to control various parameters of such an internal combustion engine. Representative examples of internal combustion parameters, systems, and/or components that may be directly or indirectly actuated using control logic and/or algorithms executed by the controller 32 include fuel injection timing, rate, and duration, throttle valve position, spark plug ignition timing (for spark-ignition engines), intake/exhaust valve timing and duration, etc. Sensors communicating input through the I/O interface from such an internal combustion engine to the controller 32 may be used to indicate turbocharger boost pressure, crankshaft position (PIP), engine rotational speed (RPM), intake manifold pressure (MAP), throttle valve position (TP), exhaust gas oxygen (EGO) or other exhaust gas component presence, intake air flow (MAF), etc.

It should be understood that the schematic illustrated in FIG. 1 is merely representative and is not intended to be limiting. Other configurations are contemplated without deviating from the scope of the disclosure. For example, the vehicle powertrain 12 may be configured to deliver power and torque to the one or both of the front wheels as opposed to the illustrated rear wheels 28.

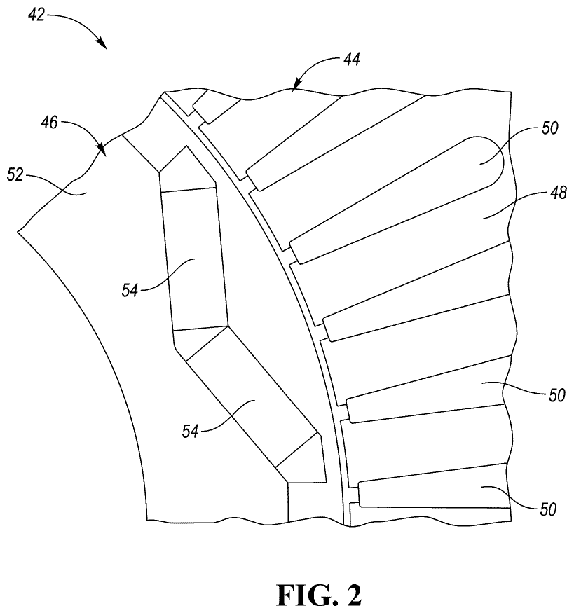

Referring to FIG. 2, a schematic illustration of a portion of an electric machine 42 is illustrated. The electric machine 42 may be representative of the M/G 14. The electric machine 42 includes a stator 44 and a rotor 46. The stator 44 may include a first core 48 and electric windings 50 that are configured to generate a magnetic field. The rotor 46 may include a second core 52 and magnets 54 disposed within the second core 52. The electric field generated by the windings 50 may interact with the magnets 54 to impart rotational motion into the rotor 46.

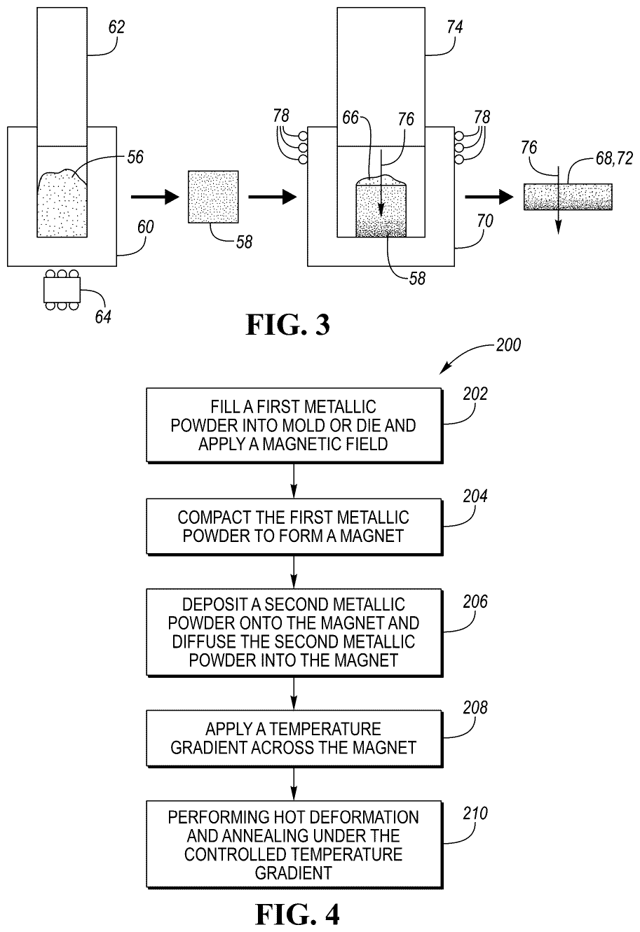

Referring to FIGS. 3 and 4, a process for producing or forming magnets (e.g., magnets 54) is illustrated. The process is illustrated schematically in FIG. 3 and as a flowchart in FIG. 4. The process may be referred to as a method 200. The method 200 begins at block 202, where particles or grains of a first metallic powder 56 are filled or placed into a mold or first die 60. A magnetic field is applied to the first metallic powder 56 to align magnetic polarities of the particles or grains of the first metallic powder 56 within the magnetic field. Aligning the magnetic polarities of the particles or grains of the first metallic powder 56 imparts the magnetic properties into a magnet 58 that is formed according to at least a portion the method 200. The magnetic field may be generated by a coil 64 that is disposed on or adjacent to the first die 60 and/or a first press 62. The magnetic field may also be applied at a same time that the first metallic powder 56 is compressed or compacted during a subsequent step at block 204. The magnetic field may be applied during the entire duration of the compressing or compacting step at block 204 or may be applied during a portion of the duration of the compressing or compacting step at block 204.

The method 200 next moves on to block 204 where the particles or grains of the first metallic powder 56 are compressed or compacted to form a magnet 58 having homogeneous coercivity. The particles or grains of the first metallic powder 56 may range between 1 and 100 nanometers in size. The particles or grains of the first metallic powder 56 may be blended prior to the step at block 202 so that the different sized particles are evenly distributed resulting in relatively or substantially homogeneous coercivity within the first metallic powder 56. This even distribution of the different sized particles carries over after the compressing or compacting step at block 204 resulting in the magnet 58 having homogeneous coercivity. It is noted that the homogeneous coercivity of the magnet 58 may correspond to a relatively or substantially homogeneous coercivity. A relatively or substantially homogeneous coercivity may correspond to a coercivity that may deviate up to 10% from a base value.

The particles or grains of the first metallic powder 56 may be comprised of Neodymium-Iron-Boron (Nd—Fe—B), Samarium-Cobalt (Sm—Co), Manganese-Bismuth (MnBi), or any other suitable material for producing magnets. The particles or grains of the first metallic powder 56 may be anisotropic magnetically and may each exhibit a magnetic polarity. The first metallic powder 56 may be compressed or compacted to form the magnet 58 at block 204 within the first die 60. More specifically, the first punch or first press 62 may compress or compact the first metallic powder 56 within the first die 60. The first press 62 may be a hot press, however, the temperature may be controlled so that no or minimal grain growth of the particles or grains within the first metallic powder 56 occurs when forming the magnet 58. The particles or grains within the first metallic powder 56 may be mechanically interlocked due to the force applied during the compressing or compacting at block 204. However, some minimal melting may occur along the grain boundaries that fuse adjacent grains to each other during compressing or compacting at block 204.

Next, the method moves on to block 206, where a second metallic powder 66 is deposited onto one or more of the exterior surfaces of the magnet 58. The second metallic powder 66 may be deposited onto the one or more exterior surfaces of the magnet 58 after the compressing or compacting step at block 204. The second metallic powder 66 is then diffused into the magnet 58 to control or adjust the coercivity of the completed magnet 68, which is eventually formed by further processing of magnet 58. Diffusion of the second metallic powder 66 into the magnet 58 may occur at a at a same time as subsequent steps corresponding to blocks 208 and 210, where the magnet 58 is deformed and heat treated to form the completed magnet 68. Diffusion of the second metallic powder 66 into the magnet 58 may occur during the entire duration of one or both of steps corresponding to blocks 208 and 210 or may occur during a portion of the duration of one or both of the steps corresponding to blocks 208 and 210. The second metallic powder 66 may be rare earth metals that increase coercivity (e.g., Neodymium (Nd), Praseodymium (Pr), Dysprosium (Dy), and Terbium (Tb)); rare earth metals that decrease coercivity (e.g., cerium (Ce) and Lanthanum (La)); non-rare metals and alloys that decrease coercivity (e.g., copper (Cu), Aluminum (Al), Aluminum alloys, Cobalt (Co), Iron (Fe)); or any other suitable material for adjusting coercivity. Dysprosium (Dy), and Terbium (Tb) may be referred to as heavy rare earth metals.

Next, at block 208, a temperature of the second die 70, the second press 74, and/or the magnet 58 is controlled to generate a temperature gradient across the magnet 58 to heat treat and/or thermal gradient anneal the magnet 58 to selectively promote grain growth within the magnet 58 such that grain size of the completed magnet 68 decreases in a direction 76 of the application of the temperature gradient corresponding to regions of lower temperature. More specifically, the direction 76 corresponds to the application of the temperature gradient that extends from higher temperatures toward lower temperatures. The coercivity and resistivity of the completed magnet 68 increases along the direction 76. The remanence of the completed magnet may decrease along direction 76.

The method 200 next moves onto block 210 where the magnet 58 is deformed within a second die 70 to form the magnet 58 into a desired shape 72. The step at block 210 corresponds to hot deforming and/or annealing of the magnet 58 and may occur while the controlled temperature gradient at block 208 is applied. More specifically, a second punch or second press 74 may deform the magnet 58 within the second die 70. In an alternative configuration, the second die 70 may be an extruder that deforms magnet 58. In yet another alternative configuration, first and second punches or presses may deform the magnet 58 within the second die 70 from opposing directions.

The application of the temperature gradient along direction 76 may be a gradual change in temperature along the magnet 58 resulting in an increase in coercivity and/or resistivity of the completed magnet 68 that may be gradual along direction 76; a gradual decrease in grain size of the completed magnet 68 along direction 76; and/or a gradual decrease in remanence of the completed magnet 68 along direction 76. For example, such gradual changes of grain size, coercivity, resistivity, and/or remanence, may be linear, exponential, etc. from a first end to a second end of the completed magnet 68 along direction 76. The grains of the completed magnet 68 along the cooler end of the temperature gradient may experience little or no grain growth and may maintain similar grain sizes as first metallic powder 56 (e.g., grains sizes that range between 1 and 100 nanometers). The grains of the completed magnet 68 along the hotter end of the temperature gradient may experience significant grain growth resulting in grains that may range between 1 and 2 micrometers in size. The grains of the completed magnet 68 between the cooler end and the hotter end of the temperature gradient will gradually increase along the completed magnet 68 from the smaller values (e.g., between 1 and 100 nanometers) on one end or region to the larger values (e.g., between 1 and 2 micrometers) on another end or region. Such an increase in grain size may be linear, exponential, etc. from the smaller values to the larger values.

The steps at blocks 208 and 210 may occur at a same time. Controlling the temperature to heat treat the magnet 58 at block 208 may be applied during the entire duration of the deforming step at block 210 or may be applied during a portion of the duration of the deforming step at block 210.

Cooling or heating coils 78 may be in contact with the second die 70 and/or the second press 74 to generate the temperature gradient across the magnet 58. The heating or cooling coils 78 may be located at any position along the second die 70 and/or the second press 74. The heating or cooling coils 78 may be configured to direct hot or cold fluid (e.g., steam or a refrigerant) to the second die 70 and/or the second press 74 to generate the temperature gradient. Alternatively, the coils 78 may be electric resistors operable to generate heat to create the temperature gradient.

It should be understood that the flowchart in FIG. 4 is for illustrative purposes only and that the method 200 should not be construed as limited to the flowchart in FIG. 4. Some of the steps of the method 200 may be rearranged while others may be omitted entirely.

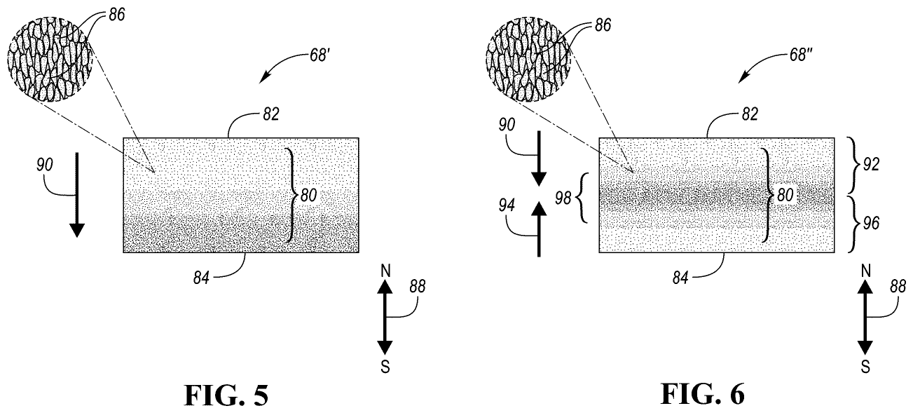

Referring to FIGS. 5 and 6, a first configuration of the completed magnet 68′ and a second configuration of the completed magnet 68″ are illustrated, respectively. The completed magnet 68 depicted in FIG. 3 could be representative of either the first configuration of the completed magnet 68′ or the second configuration of the completed magnet 68″. The first and second configurations of the completed magnet 68′, 68″ each have an array of grains 80 extending from a first end 82 of the respective magnet (e.g., magnet 68′ or magnet 68″) toward a second end 84 of the respective magnet. The grains 86 within the array of grains 80 have aligned magnetic polarities 88, and grain sizes that decrease (e.g., as described above with respect to completed magnet 68) along a first direction 90 extending from the first end 82 toward the second end 84 such that a coercivity and resistivity of the magnet increases in the first direction 90. It is noted that the remanence may decrease along the first direction 90. The first direction 90 may correction to direction 76 during the forming of the completed magnets (e.g., magnet 68, magnet 68′, or magnet 68″).

The grain sizes decrease along the first direction 90 over the entirety of the first configuration of the completed magnet 68′. However, the grain sizes of the second configuration of the completed magnet 68″ decrease along the first direction 90 over a first region 92 and along a second direction 94 over a second region 96 of the second configuration of the completed magnet 68″. The second direction 94 extends from the second end 84 toward the first end 82. Grain sizes decrease (e.g., as described above with respect to completed magnet 68) along the first and second directions 90, 94 such that a coercivity and resistivity of the second configuration of the completed magnet 68″ increases in the first and second directions 90, 94 over the first and second regions 92, 96 of the second configuration of the completed magnet 68″, respectively. It is noted that the remanence may decrease in the first and second directions 90, 94 over the first and second regions 92, 96 of the second configuration of the completed magnet 68″, respectively. The first and second directions 90, 94 may each extend from the first and second ends 82, 84, respectively, toward a middle 98 of the second configuration of the completed magnet 68″.

In an alterative configuration, the first and second directions 90, 94 may each extend away from the middle 98 and toward the first and second ends 82, 84, respectively, of the second configuration of the completed magnet 68″ (e.g., the first and second directions 90, 94 extend in a direction opposite to what is shown in FIG. 6). In such an alternatively configuration, the grain sizes of the second configuration of the completed magnet 68″ increase (e.g., as described above with respect to completed magnet 68) along the first and second directions 90, 94 from the middle 98 and toward the first and second ends 82, 84, respectively, the such that a coercivity and resistivity of the second configuration of the completed magnet 68″ increases over the first and second regions 92, 96 from the middle 98 and toward the first and second ends 82, 84, respectively. It is noted that the remanence may decrease along the first and second directions 90, 94 from the middle 98 and toward the first and second ends 82, 84, respectively.

It is noted that in FIGS. 5 and 6, the directions in which grain size, coercivity, resistivity, and remanence change (e.g., the first and second directions 90, 94) align (e.g., are parallel) with the magnetic polarities 88 of the grains 86, and hence align with the magnetic polarities of the first and second configurations of the completed magnet 68′, 68″. It should be understood, however, that the magnetic polarities 88 of the grains and the completed magnets 68′, 68″ may be orthogonal to the directions in which grain size, coercivity, resistivity, and remanence change, or may be oriented at any angle that ranges between perpendicular and parallel to the directions in which grain size, coercivity, resistivity, and remanence change.

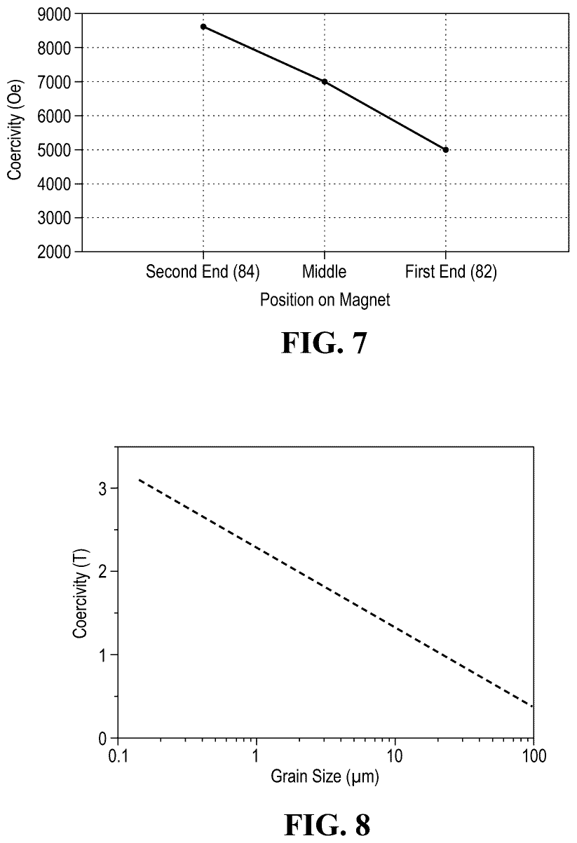

Referring to FIG. 7, a graph illustrating the gradient of coercivity across a magnet having gradually increasing grains sizes is illustrated. Assuming the graph in FIG. 7 corresponds to the coercivity gradient of the first configuration of the completed magnet 68′, the graph clearly demonstrates that coercivity (shown in units of Oersteds) increases as the grain size gradually decreases from the first end 82 toward the second end 84 of the first configuration of the completed magnet 68′.

Referring to FIG. 8, a logarithmic graph illustrates the relationship between grain size and coercivity. More specifically, the graph illustrates that coercivity (shown in units of Teslas) increases as grain size (show in units of micrometers) decreases.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A method for forming magnets comprising:
compacting particles of a metallic powder to form a magnet with homogeneous coercivity; and
thermal gradient annealing the magnet to selectively promote grain growth within the magnet such that grain size of the magnet decreases in a direction of a temperature gradient corresponding to regions of lower temperature and the coercivity increases in the direction.

2. The method of claim 1 further comprising deforming the magnet into a defined shape.

3. The method of claim 2, wherein the thermal gradient annealing and the deforming occur at a same time.

4. The method of claim 2 wherein the metallic powder comprises a first metallic powder, and further comprising depositing a second metallic powder onto an exterior surface of the magnet after the compacting.

5. The method of claim 4 further comprising diffusing the second metallic powder into the magnet to adjust the coercivity and of the magnet.

6. The method of claim 5, wherein the diffusing and deforming occur at a same time.

7. The method of claim 1 further comprising applying a magnetic field to the metallic powder to align magnetic polarities of the particles with the magnetic field.

8. The method of claim 7, wherein the applying and the compacting occur at a same time.

9. A method for forming magnets comprising:
compacting particles of a metallic powder to form a magnet with homogeneous coercivity;
deforming the magnet within a die via a press to form the magnet into a shape; and
controlling a temperature of the die, the press, or the magnet to generate a temperature gradient across the magnet to thermal gradient anneal the magnet and selectively promote grain growth within the magnet such that grain size of the magnet decreases in a direction of the temperature gradient corresponding to regions of lower temperature and the coercivity increases in the direction.

10. The method of claim 9, wherein the metallic powder comprises a first metallic powder, and further comprising depositing a second metallic powder onto an exterior surface of the magnet after the compacting.

11. The method of claim 10 further comprising diffusing the second metallic powder into the magnet to adjust the coercivity.

12. The method of claim 11, wherein the diffusing and the deforming occur at a same time.

13. The method of claim 9 further comprising applying a magnetic field to the metallic powder to align magnetic polarities of the particles with the magnetic field.

14. The method of claim 13, wherein the applying and compacting occur at a same time.

15. The method of claim 9, wherein the deforming and controlling occur at a same time.

16. A magnet comprising:
an array of grains extending from a first end of the magnet toward a second end of the magnet, the grains within the array having aligned magnetic polarities and grain sizes that decrease along a first direction extending from the first end toward the second end such that a coercivity of the magnet increases in the first direction.

17. The magnet of claim 16, wherein the grain sizes decrease (i) along the first direction over a first region of the magnet and (ii) along a second direction extending from the second end toward the first end over a second region of the magnet such that a coercivity of the magnet increases in the first and second directions.

18. The magnet of claim 17, wherein the first and second directions each extend toward a middle of the magnet.

19. The magnet of claim 17, wherein the first and second directions each extend away from a middle of the magnet.

20. The magnet of claim 16, wherein the grain sizes decrease linearly along the first direction.
